(19) United States
(12) Patent Application Publication
(10) Pub. No.: US 2023/0375678 A1
(43) Pub. Date: Nov. 23, 2023

(54) PHOTORECEIVER HAVING THRESHOLDED DETECTION

(71) Applicant: Allegro MicroSystems, LLC, Manchester, NH (US)

(72) Inventors: Bryan Cadugan, Bedford, NH (US); Adam Lee, Portland, OR (US); George Williams, Vashon, WA (US)

(73) Assignee: Allegro MicroSystems, LLC, Manchester, NH (US)

(21) Appl. No.: 17/663,896

(22) Filed: May 18, 2022

(51) Int. Cl. G01S 7/4863; G01S 7/4865; G01S 7/487; G01S 17/32

(52) U.S. Cl. CPC G01S 7/4863; G01S 7/4865; G01S 7/4873; G01S 17/32

(57) ABSTRACT

Methods and apparatus for processing signal return of photons reflected by a target illuminated by laser energy using at least one threshold. Parameters of pulses in the signal return exceeding one or more thresholds can be stored in memory. Example parameters include time of flight (ToF) and a time over threshold (ToT).

### BACKGROUND

As is known in the art, some known ranging systems can include laser radar (ladar), light detection and ranging (lidar), and/or range-finding systems, to measure the distance to objects in a scene. A laser ranging and imaging system emits pulses toward a particular location and measures the return echoes to extract ranges to objects at the location, from which a three-dimensional representation of the objects can be computed.

Time-of-flight laser ranging systems generally work by emitting a laser pulse and recording the time it takes for the laser pulse to travel to a target, reflect, and return to a photoreceiver. The laser ranging instrument records the time of the outgoing pulse and records the time that a laser pulse returns. The difference between these two times is the time of flight to and from the target. Using the speed of light, the round-trip time of the pulses is used to calculate the distance to the target.

### SUMMARY

Example embodiments of the disclosure provide methods and apparatus for processing signal return in a system that processes photonic return, such as a LIDAR system. In some embodiments, signal returns are sorted to keep the N highest metric returns. Once there are N returns in memory, if another return comes along that has a greater metric than one of the returns in memory, the new return replaces the lowest metric return. In other embodiments, a detection metric is based on pulse amplitude, which can be determined by an ADC, so that the actual maximum amplitude of the returned pulse is known. Example amplitude processing can include using a peak detection and track-hold circuit to capture the return amplitude, using a ToT measurement with a fixed threshold value, using a single ToT with a programmable threshold value, and/or using multiple programmable ToT levels (MToT), where the highest threshold value exceeded by the pulse, and the ToT of that threshold, is selected to represent the pulse amplitude.

In example embodiments of the disclosure, one or more threshold values for the signal return can be programmed to have time-varying characteristics with respect to the time of the transmitted laser pulse. In some embodiments, the voltage threshold levels may be held constant during the time of flight of the laser pulse. In embodiments, one or more of the thresholds may be decreased in value during the time of flight of the laser pulse to compensate for the reduction in the return pulse return values as a function of target range (R). Examples of range dependent thresholds may be proportionate to threshold values for Lambertian targets larger than the laser beam diameter decay approximately as 1/R\hat{ }2, threshold values for wire, linear targets larger than the laser beam diameter decay approximately as 1/R\hat{ }3, and threshold values for Lambertian targets smaller than the laser beam diameter decay approximately as 1/R\hat{ }4.

In some embodiments, threshold levels can be reduced in value only after a laser pulse is detected. In other embodiments, the threshold levels may be reduced in value a time interval before or after a laser pulse is transmitted.

In embodiments, a threshold detector may include logic that can be used to augment the pulse detection, such as rejecting the recording of a return that is either higher or lower than a fixed or programmable threshold level, rejecting the recording of a return that is either higher or lower than one or more threshold levels compared to that of one or more other threshold levels, only processing the ToT of the highest threshold level detected, rejecting pulses larger than a certain threshold MToT or ToT value, and/or rejecting pulses lower than a certain threshold MToT or ToT value.

In some embodiments, in addition to, or in place of sorting based on amplitude, other criterion can be used to sort the pulses, such as rejecting a return that is either higher or lower than a level, after the pulse amplitude is compensated for the range. A buffer can be resorted or rebalanced to give more weight to those returns that follow a predictable decay higher for keeping them in the buffer assuming that they were multiple returns from the same outbound pulse. In some embodiments, a detector can reject a return that at multiple thresholds is wider or narrower than the known pulse width of the laser by some margin taking into account the shape of the laser. In addition, returns that do not conform to a shape over one or more threshold values may be rejected, such as thresholds based on ratios of the Time over Threshold at various thresholds to extract the shape. In some embodiments, a metric is derived for sorting based on the sum of the products of the threshold level detected and the TOT. In some embodiments, adding returns to memory may be range gated after a certain time has elapsed. Range gates may include more than one time span in which pulses are rejected from the sorting. In order to avoid dead time in the receiver, the sorting process may be pipelined following the receiver timing circuit (time-to-digital converter or TDC) such that the sorting process can be implemented without effecting the pulse-pair resolution of the receiver system (ability to see multiple, closely spaced optical or dark returns).

In one aspect, a method comprises: receiving, at a photodetector of a detector system, signal return photons reflected by a target illuminated by laser energy; comparing the signal return to at least one threshold to determine at least one amplitude and/or Time of Flight (ToF) parameter of the signal return to sort the signal return; and storing, in a memory, at least one parameter of pulses in the signal return that exceeds the at least one threshold, wherein the at least one parameter includes the time of flight (ToF) and/or the time over threshold (ToT).

A method can further include one or more of the following features: overwriting a stored value for the at least one parameter having a value less than a parameter of a new pulse, the at least one threshold includes at least three voltage thresholds, the at least threshold comprises first and second thresholds that decay over range, and further including identifying as noise signal return that is above the first threshold or below the second threshold, the first and second thresholds are programmed to decay proportional to a range of calculated target reflectivities at various ranges, the at least one threshold comprises a threshold that decays, the at least threshold comprises first and second thresholds that decay over range 1/R^{x}, where x is an number between 1 and 10, the decay is between 1/R\hat{ }2 and 1/R\hat{ }4, where R is range, the decay is based on estimated optical returns corresponding to target size, orientation, and/or reflectivity, the decay is a function of atmospheric attenuation coefficients A, the decay is proportional to EXP(−A*R*2), where A, expressed in 1/m, is between values 1E-2 (1/m) and 1E-5 (1/m) for 1550 nm light representing dense fog and clear visibility respectively, the decay is a function of physical target characteristics including size, orientation, and reflectivity, and atmospheric conditions, the decay is proportional to EXP(−A*R*2)*1/R^{x}, the decay is proportional to EXP(−A*R*2)*1/R^{s}C, delaying the decay for a period of time D to accommodate a limited dynamic range of circuitry, the at least one threshold is referenced to a noise level of the detector system, the first threshold corresponds to a high trigger and the second threshold corresponds to a low trigger, wherein the high and low triggers are selected based on characteristics of the laser beam that illuminated the target, the high and low triggers are selected based on a width of pulses generated by the laser, the high and low triggers are selected based on a leakage characteristic of the laser, using the high and low triggers to record rising and falling edges of a pulse and using differences in the time of the rising and falling signal edges to determine pulse amplitude using time over threshold (TOT), the at least one threshold comprises first and second thresholds that decay over range, and further including: identifying as noise the signal return that is above the first threshold or below the second threshold; and adjusting the first and second thresholds based upon updated target reflectivity, the at least one threshold comprises first and second thresholds that decay over range, and further including: identifying as noise signal return that is above the first threshold or below the second threshold; and adjusting the first and second thresholds based upon updated decay information of the signal return, removing information stored in the memory based on the updated decay information, a pipeline pulse sorter to compare new pulse parameter data with the stored pulse parameter data to selectively overwrite the stored pulse parameter data, overwriting the stored pulse parameter data with more relevant new pulse parameter data based on the comparisons in the pipeline pulse sorter, one or more of the threshold levels are dynamically adjustable as a function of scan angle, the at least one threshold is adjustable as a function of an output pulse energy of the laser beam, the least one threshold is adjustable as a function of an output pulse beam divergence and/or beam shape of the laser beam, the at least one threshold is adjustable as a function of an output pulse beam temporal shape of the laser beam, and/or the at least one threshold comprises a multiple of a detector noise level.

In another aspect, a system comprises: a photodetector of a detector system to receive signal return photons reflected by a target illuminated by laser energy; a discriminator to compare the signal return to at least one threshold to determine at least one amplitude and/or Time of Flight (ToF) parameter of the signal return to sort the signal return; and a memory to store at least one parameter of pulses in the signal return that exceeds the at least one threshold, wherein the at least one parameter includes the time of flight (ToF) and/or the time over threshold (ToT).

A system can further include one or more of the following features: overwriting a stored value for the at least one parameter having a value less than a parameter of a new pulse, the at least one threshold includes at least three voltage thresholds, the at least threshold comprises first and second thresholds that decay over range, and further including identifying as noise signal return that is above the first threshold or below the second threshold, the first and second thresholds are programmed to decay proportional to a range of calculated target reflectivities at various ranges, the at least one threshold comprises a threshold that decays, the at least threshold comprises first and second thresholds that decay over range 1/R^{x}, where x is an number between 1 and 10, the decay is between 1/R\hat{ }2 and 1/R\hat{ }4, where R is range, the decay is based on estimated optical returns corresponding to target size, orientation, and/or reflectivity, the decay is a function of atmospheric attenuation coefficients A, the decay is proportional to EXP(−A*R*2), where A, expressed in 1/m, is between values 1E-2 (1/m) and 1E-5 (1/m) for 1550 nm light representing dense fog and clear visibility respectively, the decay is a function of physical target characteristics including size, orientation, and reflectivity, and atmospheric conditions, the decay is proportional to EXP(−A*R*2)*1/R^{x}, the decay is proportional to EXP(−A*R*2)*1/R^{s}C, delaying the decay for a period of time D to accommodate a limited dynamic range of circuitry, the at least one threshold is referenced to a noise level of the detector system, the first threshold corresponds to a high trigger and the second threshold corresponds to a low trigger, wherein the high and low triggers are selected based on characteristics of the laser beam that illuminated the target, the high and low triggers are selected based on a width of pulses generated by the laser, the high and low triggers are selected based on a leakage characteristic of the laser, using the high and low triggers to record rising and falling edges of a pulse and using differences in the time of the rising and falling signal edges to determine pulse amplitude using time over threshold (TOT), the at least one threshold comprises first and second thresholds that decay over range, and further including: identifying as noise the signal return that is above the first threshold or below the second threshold; and adjusting the first and second thresholds based upon updated target reflectivity, the at least one threshold comprises first and second thresholds that decay over range, and further including: identifying as noise signal return that is above the first threshold or below the second threshold; and adjusting the first and second thresholds based upon updated decay information of the signal return, removing information stored in the memory based on the updated decay information, a pipeline pulse sorter to compare new pulse parameter data with the stored pulse parameter data to selectively overwrite the stored pulse parameter data, overwriting the stored pulse parameter data with more relevant new pulse parameter data based on the comparisons in the pipeline pulse sorter, one or more of the threshold levels are dynamically adjustable as a function of scan angle, the at least one threshold is adjustable as a function of an output pulse energy of the laser beam, the least one threshold is adjustable as a function of an output pulse beam divergence and/or beam shape of the laser beam, the at least one threshold is adjustable as a function of an output pulse beam temporal shape of the laser beam, and/or the at least one threshold comprises a multiple of a detector noise level.

### BRIEF DESCRIPTION OF THE DRAWINGS

The foregoing features of this disclosure, as well as the disclosure itself, may be more fully understood from the following description of the drawings in which:

FIG. 1 shows an example LIDAR time-of-flight sensor including photodetectors and return processing in accordance with example embodiments of the disclosure;

FIG. 2 shows a ROIC storing N returns in the available memory capacity of the ROIC;

FIG. 3 shows detection system with a return sorter in front of the memory elements;

FIGS. 4A-C show an example series of pulses arriving at different times, having different amplitudes, and processing in memory;

FIG. 5 shows example circuits having a fast ADC and a peak and hold functionality;

FIG. 6 shows a detector system having a photodetector coupled to an analog front end (AFE) the output of which is coupled to a series of voltage discriminators each having a respective voltage threshold input;

FIG. 7 shows a detection system that includes functionality to reduce false detections;

FIG. 7A shows an example circuit implementation of FIG. 7 including a photodiode providing an input to an amplifier generating an output that is coupled to inputs of first and second comparators;

FIG. 7B shows an example implementation in which the first voltage threshold Vth1 is generated by a high speed digital-to-analog converter (DAC) or a DAC setting a decaying RC circuit;

FIG. 8 shows an example plot of a first laser pulse generated by a first type of laser, such as a fiber laser, and a second laser pulse generated by a second type of laser, such as a diode pumped solid state (DPSS) laser;

FIG. 9 shows an example signal return that can be processed in accordance with example embodiments of the disclosure;

FIG. 10 shows an example pulse sorter embodiment for the system of FIG. 3;

FIG. 11 shows return in logarithmic scale from a notional laser having divergence including returns from a target that is larger than the laser beam size (at range) and returns where the size of the laser beam becomes larger than the target;

FIG. 12 shows example photon returns from three different targets on a logarithmic scale;

FIG. 13 shows the photons returned from a laser is a function of atmospheric attenuation;

FIG. 14 shows a series of photon referred voltage levels from a multiple threshold (MT) detector;

FIG. 15 shows a series of photon referred voltage levels from a multiple threshold (MT) detector;

FIG. 16 shows decaying thresholds falling from a high photon equivalent voltage level to a threshold level related to the SNR;

FIG. 17 shows decaying thresholds falling from a high photon equivalent voltage level to a threshold level related to the SNR;

FIG. 18 shows threshold decay initiated after a time delay;

FIG. 19 shows threshold levels initiated after a delay based on the estimated returns from different sized and shaped targets, as a function of range (time);

FIG. 20 shows an example system having multiple threshold detectors configured to receive signal return from a photodetector; and

FIG. 21 is a schematic representation of an example computer than can perform at least a portion of the processing described herein.

### DETAILED DESCRIPTION

Prior to describing example embodiments of the disclosure some information is provided. Laser ranging systems can include laser radar (ladar), light-detection and ranging (lidar), and rangefinding systems, which are generic terms for the same class of instrument that uses light to measure the distance to objects in a scene. This concept is similar to radar, except optical signals are used instead of radio waves. Similar to radar, a laser ranging and imaging system emits a pulse toward a particular location and measures the return echoes to extract the range.

Laser ranging systems generally work by emitting a laser pulse and recording the time it takes for the laser pulse to travel to a target, reflect, and return to a photoreceiver. The laser ranging instrument records the time of the outgoing pulse—either from a trigger or from calculations that use measurements of the scatter from the outgoing laser light—and then records the time that a laser pulse returns. The difference between these two times is the time of flight to and from the target. Using the speed of light, the round-trip time of the pulses is used to calculate the distance to the target.

Lidar systems may scan the beam across a target area to measure the distance to multiple points across the field of view, producing a full three-dimensional range profile of the surroundings. More advanced flash lidar cameras, for example, contain an array of detector elements, each able to record the time of flight to objects in their field of view.

When using light pulses to create images, the emitted pulse may intercept multiple objects, at different orientations, as the pulse traverses a 3D volume of space. The echoed laser-pulse waveform contains a temporal and amplitude imprint of the scene. By sampling the light echoes, a record of the interactions of the emitted pulse is extracted with the intercepted objects of the scene, allowing an accurate multi-dimensional image to be created. To simplify signal processing and reduce data storage, laser ranging and imaging can be dedicated to discrete-return systems, which record only the time of flight (TOF) of the first, or a few, individual target returns to obtain angle-angle-range images. In a discrete-return system, each recorded return corresponds, in principle, to an individual laser reflection (i.e., an echo from one particular reflecting surface, for example, a tree, pole or building). By recording just a few individual ranges, discrete-return systems simplify signal processing and reduce data storage, but they do so at the expense of lost target and scene reflectivity data. Because laser-pulse energy has significant associated costs and drives system size and weight, recording the TOF and pulse amplitude of more than one laser pulse return per transmitted pulse, to obtain angle-angle-range-intensity images, increases the amount of captured information per unit of pulse energy. All other things equal, capturing the full pulse return waveform offers significant advantages, such that the maximum data is extracted from the investment in average laser power. In full-waveform systems, each backscattered laser pulse received by the system is digitized at a high sampling rate (e.g., 500 MHz to 1.5 GHz). This process generates digitized waveforms (amplitude versus time) that may be processed to achieve higher-fidelity 3D images.

Of the various laser ranging instruments available, those with single-element photoreceivers generally obtain range data along a single range vector, at a fixed pointing angle. This type of instrument—which is, for example, commonly used by golfers and hunters—either obtains the range (R) to one or more targets along a single pointing angle or obtains the range and reflected pulse intensity (I) of one or more objects along a single pointing angle, resulting in the collection of pulse range-intensity data, (R,I)ᵢ, where i indicates the number of pulse returns captured for each outgoing laser pulse.

More generally, laser ranging instruments can collect ranging data over a portion of the solid angle of a sphere, defined by two angular coordinates (e.g., azimuth and elevation), which can be calibrated to three-dimensional (3D) rectilinear cartesian coordinate grids; these systems are generally referred to as 3D lidar and ladar instruments. The terms “lidar” and “ladar” are often used synonymously and, for the purposes of this discussion, the terms “3D lidar,” “scanned lidar,” or “lidar” are used to refer to these systems without loss of generality. 3D lidar instruments obtain three-dimensional (e.g., angle, angle, range) data sets. Conceptually, this would be equivalent to using a rangefinder and scanning it across a scene, capturing the range of objects in the scene to create a multi-dimensional image. When only the range is captured from the return laser pulses, these instruments obtain a 3D data set (e.g., angle, angle, range)ₙ, where the index n is used to reflect that a series of range-resolved laser pulse returns can be collected, not just the first reflection.

Some 3D lidar instruments are also capable of collecting the intensity of the reflected pulse returns generated by the objects located at the resolved (angle, angle, range) objects in the scene. When both the range and intensity are recorded, a multi-dimensional data set [e.g., angle, angle, (range-intensity)ₙ] is obtained. This is analogous to a video camera in which, for each instantaneous field of view (FOV), each effective camera pixel captures both the color and intensity of the scene observed through the lens. However, 3D lidar systems, instead capture the range to the object and the reflected pulse intensity.

Lidar systems can include different types of lasers, including those operating at different wavelengths, including those that are not visible (e.g., those operating at a wavelength of 840 nm or 905 nm), and in the near-infrared (e.g., those operating at a wavelength of 1064 nm or 1550 nm), and the thermal infrared including those operating at wavelengths known as the “eyesafe” spectral region (i.e., generally those operating at a wavelength beyond 1300-nm, which is blocked by the cornea), where ocular damage is less likely to occur. Lidar transmitters are generally invisible to the human eye. However, when the wavelength of the laser is close to the range of sensitivity of the human eye—roughly 350 nm to 730 nm—the light may pass through the cornea and be focused onto the retina, such that the energy of the laser pulse and/or the average power of the laser must be lowered to prevent ocular damage. Thus, a laser operating at, for example, 1550 nm, can—without causing ocular damage—generally have 200 times to 1 million times more laser pulse energy than a laser operating at 840 nm or 905 nm.

One challenge for a lidar system is detecting poorly reflective objects at long distance, which requires transmitting a laser pulse with enough energy that the return signal-reflected from the distant target—is of sufficient magnitude to be detected. To determine the minimum required laser transmission power, several factors must be considered. For instance, the magnitude of the pulse returns scattering from the diffuse objects in a scene is proportional to their range and the intensity of the return pulses generally scales with distance according to 1/R\hat{ }4 for small objects and 1/R\hat{ }2 for larger objects; yet, for highly-specularly reflecting objects (i.e., those reflective objects that are not diffusively-scattering objects), the collimated laser beams can be directly reflected back, largely unattenuated. This means that—if the laser pulse is transmitted, then reflected from a target 1 meter away—it is possible that the full energy (J) from the laser pulse will be reflected into the photoreceiver; but—if the laser pulse is transmitted, then reflected from a target 333 meters away—it is possible that the return will have a pulse with energy approximately 10\hat{ }12 weaker than the transmitted energy. To provide an indication of the magnitude of this scale, the 12 orders of magnitude (10\hat{ }12) is roughly the equivalent of: the number of inches from the earth to the sun, 10× the number of seconds that have elapsed since Cleopatra was born, or the ratio of the luminous output from a phosphorescent watch dial, one hour in the dark, to the luminous output of the solar disk at noon.

In many cases of lidar systems highly-sensitive photoreceivers are used to increase the system sensitivity to reduce the amount of laser pulse energy that is needed to reach poorly reflective targets at the longest distances required, and to maintain eyesafe operation. Some variants of these detectors include those that incorporate photodiodes, and/or offer gain, such as avalanche photodiodes (APDs) or single-photon avalanche detectors (SPADs). These variants can be configured as single-element detectors,-segmented-detectors, linear detector arrays, or area detector arrays. Using highly sensitive detectors such as APDs or SPADs reduces the amount of laser pulse energy required for long-distance ranging to poorly reflective targets. The technological challenge of these photodetectors is that they must also be able to accommodate the incredibly large dynamic range of signal amplitudes.

As dictated by the properties of the optics, the focus of a laser return changes as a function of range; as a result, near objects are often out of focus. Furthermore, also as dictated by the properties of the optics, the location and size of the “blur”—i.e., the spatial extent of the optical signal—changes as a function of range, much like in a standard camera. These challenges are commonly addressed by using large detectors, segmented detectors, or multi-element detectors to capture all of the light or just a portion of the light over the full-distance range of objects. It is generally advisable to design the optics such that reflections from close objects are blurred, so that a portion of the optical energy does not reach the detector or is spread between multiple detectors. This design strategy reduces the dynamic range requirements of the detector and prevents the detector from damage.

Acquisition of the lidar imagery can include, for example, a 3D lidar system embedded in the front of car, where the 3D lidar system, includes a laser transmitter with any necessary optics, a single-element photoreceiver with any necessary dedicated or shared optics, and an optical scanner used to scan (“paint”) the laser over the scene. Generating a full-frame 3D lidar range image—where the field of view is 20 degrees by 60 degrees and the angular resolution is 0.1 degrees (10 samples per degree)—requires emitting 120,000 pulses [(20*10*60*10)=120,000)]. When update rates of 30 frames per second are required, such as is required for automotive lidar, roughly 3.6 million pulses per second must be generated and their returns captured.

There are many ways to combine and configure the elements of the lidar system including considerations for the laser pulse energy, beam divergence, detector array size and array format (single element, linear, 2D array), and scanner to obtain a 3D image. If higher power lasers are deployed, pixelated detector arrays can be used, in which case the divergence of the laser would be mapped to a wider field of view relative to that of the detector array, and the laser pulse energy would need to be increased to match the proportionally larger field of view. For example— compared to the 3D lidar above—to obtain same-resolution 3D lidar images 30 times per second, a 120,000-element detector array (e.g., 200×600 elements) could be used with a laser that has pulse energy that is 120,000 times greater. The advantage of this “flash lidar” system is that it does not require an optical scanner; the disadvantages are that the larger laser results in a larger, heavier system that consumes more power, and that it is possible that the required higher pulse energy of the laser will be capable of causing ocular damage. The maximum average laser power and maximum pulse energy are limited by the requirement for the system to be eyesafe.

As noted above, while many lidar system operate by recording only the laser time of flight and using that data to obtain the distance to the first target return (closest) target, some lidar systems are capable of capturing both the range and intensity of one or multiple target returns created from each laser pulse. For example, for a lidar system that is capable of recording multiple laser pulse returns, the system can detect and record the range and intensity of multiple returns from a single transmitted pulse. In such a multi-pulse lidar system, the range and intensity of a return pulse from a closer-by object can be recorded, as well as the range and intensity of later reflection(s) of that pulse—one(s) that moved past the closer-by object and later reflected off of more-distant object(s). Similarly, if glint from the sun reflecting from dust in the air or another laser pulse is detected and mistakenly recorded, a multi-pulse lidar system allows for the return from the actual targets in the field of view to still be obtained.

The amplitude of the pulse return is primarily dependent on the specular and diffuse reflectivity of the target, the size of the target, and the orientation of the target. Laser returns from close, highly-reflective objects, are many orders of magnitude greater in intensity than the intensity of returns from distant targets. Many lidar systems require highly sensitive photodetectors, for example APDs, which along with their CMOS amplification circuits may be damaged by very intense laser pulse returns.

For example, if an automobile equipped with a front-end lidar system were to pull up behind another car at a stoplight, the reflection off of the license plate may be significant perhaps 10\hat{ }12 higher than the pulse returns from targets at the distance limits of the lidar system. When a bright laser pulse is incident on the photoreceiver, the large current flow through the photodetector can damage the detector, or the large currents from the photodetector can cause the voltage to exceed the rated limits of the CMOS electronic amplification circuits, causing damage. For this reason, it is generally advisable to design the optics such that the reflections from close objects are blurred, so that a portion of the optical energy does not reach the detector or is spread between multiple detectors.

However, capturing the intensity of pulses over a larger dynamic range associated with laser ranging may be challenging because the signals are too large to capture directly. One can infer the intensity by using a recording of a bit-modulated output obtained using serial-bit encoding obtained from one or more voltage threshold levels. This technique is often referred to as time-over-threshold (TOT) recording or, when multiple-thresholds are used, multiple time-over-threshold (MTOT) recording.

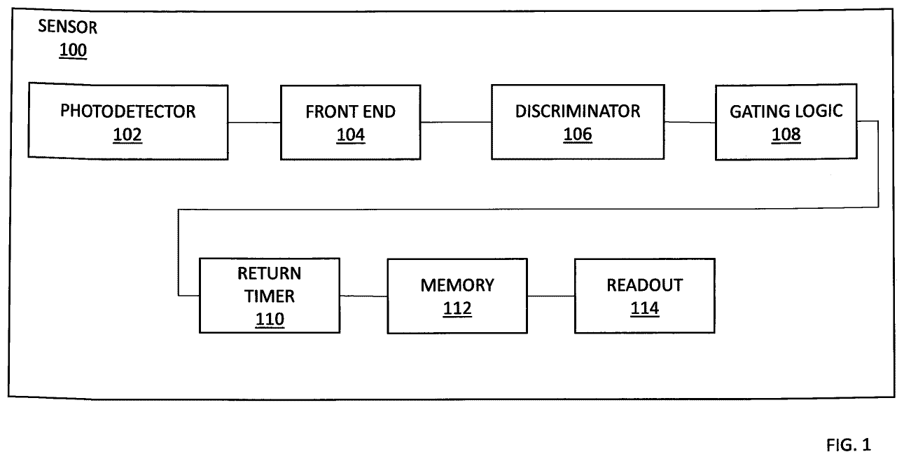

FIG. 1 shows an example LIDAR time-of-flight sensor 100 including photodetectors and return processing in accordance with example embodiments of the disclosure. The sensor 100 can include a photodetector, such as a photodiode array 102, to detect photons reflected from a target illuminated with transmitted energy. A front-end circuit 104, which may include an amplifier for example, receives a current pulse generated by an optical pulse on the photodiode 102 and converts the current signal into an output, for example, an output voltage pulse. A discriminator circuit 106, such as a voltage discriminator, can determine if the current pulse, or its representation after signal conversion by the front-end circuit, is above one or more thresholds. Gating logic 108 receives an output from the discriminator 106 to match received signals with transmitted signals, for example. A return timer circuit 110, which can include a time-to-digital converter (TDC) for generating timestamps, can determine the time from signal transmission to signal return so that a distance from the sensor to the target can be determined based on so-called time of flight (ToF). A memory 112 can store signal information, such as time of flight, time over threshold, and the like. A readout circuit 114-enables information to be read from the sensor. Return processing can include comparing timing return information to timing reference information and converting timing return information into specific range information. Additionally, the circuit may correct for static or dynamic errors using calibration and correction algorithms.

Often there are multiple optical pulse “returns” that come back from a single transmitted laser pulse, which reflects off objects within the receiver pixel field-of-view. The return pulses have an amplitude that is dependent on the emitted laser pulse energy, the atmospheric attenuation, the size of the reflecting portion of the target with respect to the laser pulse, the reflectivity of the target, and the orientation of the target with respect to the orientation of the optical axis of the LiDAR photoreceiver.

In addition to optical pulse returns, electrical noise in the photodetector and ROIC can result in “dark returns” that are indistinguishable from optical returns in the receiver. Similarly, background optical noise, from ambient light sources, such as the sun, can cause false returns, during times when pulse returns are not present. These returns can also be referred to as dark returns. Following acquisition of optical and dark returns, over a defined time (corresponding to a search range), the ROIC will output one or more of these returns, in the form of a digital code representing the timing of the returned pulse versus a fixed reference time (time=0, T=0, or T0) and possibly the amplitude of the pulse, which may be a sampled value or may be represented by one or more Time over Threshold (ToT) measurements.

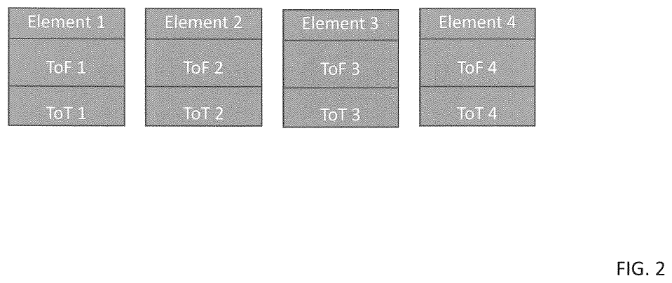

As shown in FIG. 2, during acquisition, in example embodiments a ROIC stores N of these returns in the available memory capacity of the ROIC by keeping the first N returns that exceed an amplitude threshold. In the illustrated embodiment, the ROIC includes, first, second, third, and fourth memory elements. The first return that exceeds a threshold is stored in the first memory element, the second return that exceeds the threshold is stored in the second memory element, and so on. Once four returns exceed the threshold, no additional returns can be stored.

In the illustrated embodiment, each memory element stores the first ToF— Time of Flight (from Time=0) that exceeds a ToF threshold and the first ToT— Time over Threshold that exceeds a ToT threshold.

In example embodiments, ROICs, after a Time=0, returns are identified that exceed a particular amplitude threshold. Then a Time of Flight is measured from the Time=0 point, which can occur at the time the input crosses the threshold or other suitable method, such as the midpoint of the time over threshold. The ROIC stores the time information (from Time=0) and possibly other information about the pulse, such as amplitude or Time over Threshold. Each of these sets of data is stored for one or more returns. In the illustrated embodiment, each memory element stores ToF and ToT values for a return.

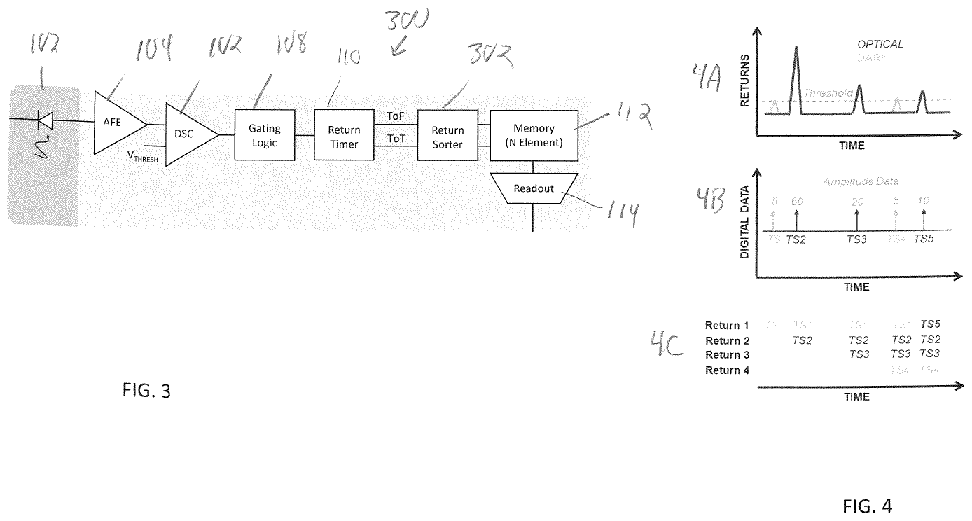

FIG. 3 shows detection system 300 with a return sorter 302 added to the sensor 100 of FIG. 1 in front of the memory elements 112, where like reference numbers indicate like elements. In an example embodiment, when a ToT value or other amplitude value is sensed that is larger than a value in an existing memory element, the return sorter 302 stores the newly detected larger value by overwriting the existing data in memory 112.

In embodiments, the return sorter 302 includes N comparators for each memory element. In other embodiments, the return sorter 302 maintains a sorted version of the memory. In some embodiments, the return sorter 302 compares new values against the smallest value in any of the memory elements (once the memory is full) and replaces the smallest value once a higher return is sensed.

As can be seen in FIGS. 4A-C, in an example sequence, a series of pulses, which may be generated by dark current and/or optical energy, arrive over time. In order the pulses arrive as TS1, TS2, TS3, TS4, and TS5, each having a respective amplitude value.

As best shown in FIG. 4C, after memory is full when pulse TS4 is stored, the next pulse may result in one of the stored values being overwritten if the value of the new pulse is greater than a stored value. In the illustrated embodiment, the fifth pulse TS5 has an amplitude value of 10, which is greater than the value of TS1. The value for TS5 overwrites the value stored for TS1. It is understood that the value can correspond to amplitude, ToT, and/or other suitable value. In some embodiments, dark and optical pulses are stored in separate memories so that only values of the same type will be overwritten by a new pulse.

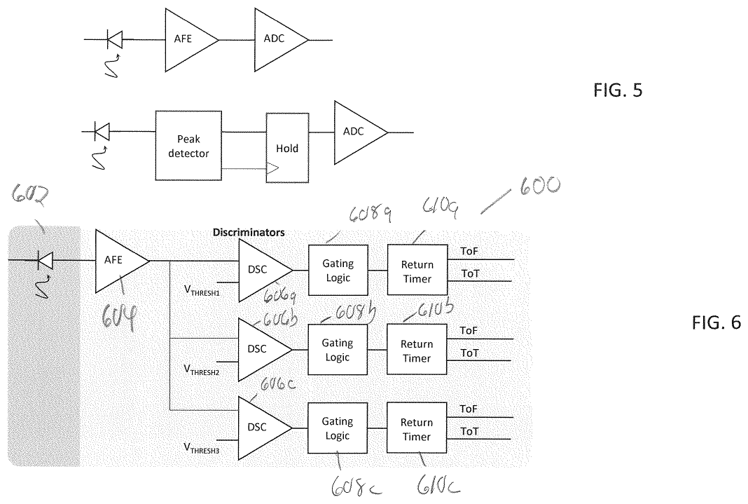

In another aspect, embodiments of the disclosure a relatively fast ADC can track actual amplitude over time and/or track and measure a pulse peak after cross a threshold. A peak detect and hold circuit capture a peak value and hold it until measurement at a slower rate. FIG. 5 shows example circuits having a fast ADC and a peak and hold functionality.

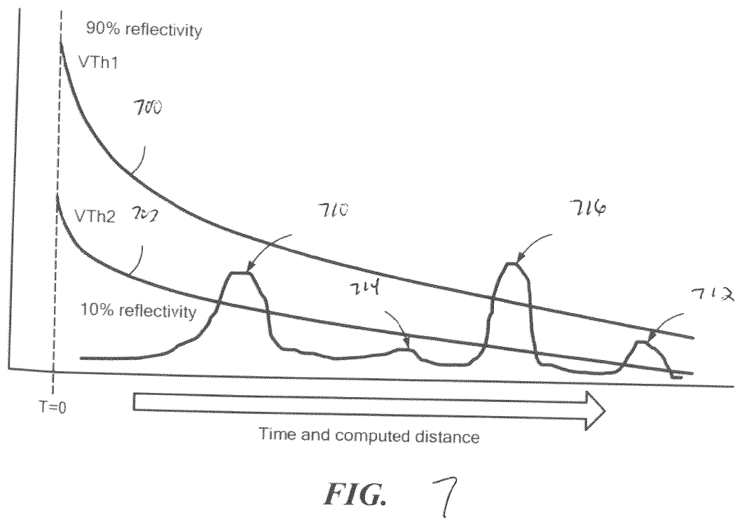

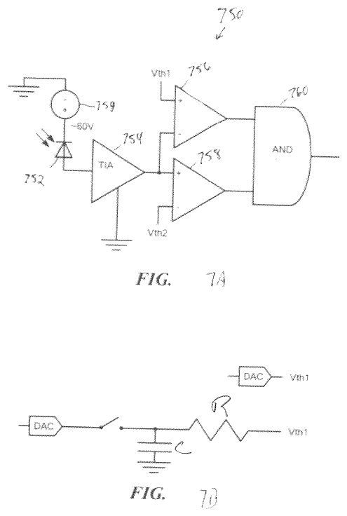

FIG. 6 shows a detector system 600 having a photodetector 602 coupled to an analog front end (AFE) 604 the output of which is coupled to a series of voltage discriminators 606a,b,c each having a respective voltage threshold input VTHRESH1, VTHRESH2, VTHRESH3. Respective outputs of the voltage discriminators 606 are coupled to gating logic modules 608a,b,c each coupled to respective return timers 610a,b,c. In embodiments, the voltage thresholds are programmable. In the illustrated embodiment, VThresh1<VThresh2<Vthresh3 where amplitude is 1^{st} order the highest threshold that outputs a return (as it had to have crossed it), 2^{nd} order is the ToT or other amplitude value measured as part of the highest threshold.

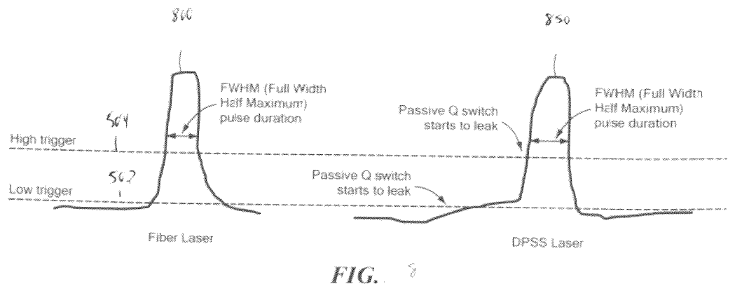

FIG. 7 shows a detection technique for reducing false detections. A first curve 700 shows amplitude over time for 90% reflectivity for a given target and a second curve 702 shows 10% reflectivity. The first curve 700 corresponds to a first voltage threshold Vth1 and the second curve 702 corresponds to a second voltage threshold Vth2. As can be seen, the thresholds decay over range/time.

In the illustrative embodiment, voltage pulses 710, 712 between the first and second voltage thresholds Vth1, Vth2, are generated by a likely real return. A voltage pulse 714 below the second voltage threshold Vth2 is likely noise. A voltage pulse 716 above the first voltage threshold Vth1 is likely noise.

As can be seen, decay of the returned photonic energy vs. distance is modulated by reflectivity. A range of reflectivities can be selected based on the characteristics of the transmitted pulses, expected target characteristics, expected distances, and the like. The detector can be calibrated with an actual source and the response energy can be modeled for a reasonable range of response over time. This increases safety by improving false pulse rejection. In addition, real pulses can be better discerned.

FIG. 7A shows an example circuit implementation 750 including a photodiode 752 providing an input to an amplifier 754 generating an output that is coupled to inputs of first and second comparators 756, 758. In the illustrated embodiment, a 60V bias voltage 759 is applied to the photodiode 752. It is understood that any practical bias voltage level can be used. A first voltage threshold Vth1 is coupled to a second input of the first comparator 756 and a second voltage threshold Vth2 is coupled to a second input of the second comparator 758. The outputs of the first and second comparators 756, 758 are provided as inputs to an AND gate 760, which changes state when the output of the amplifier 754 is between the first and second voltage thresholds Vth1, Vth2 in accordance with the first and second curves 700, 702 of FIG. 7, for example.

FIG. 7B shows an example implementation in which the first voltage threshold Vth1 is generated by a high speed digital-to-analog converter (DAC) or a DAC setting a decaying RC circuit.

FIG. 8 shows an example plot of a first laser pulse 800 generated by a first type of laser, such as a fiber laser, and a second laser pulse 850 generated by a second type of laser, such as a diode pumped solid state (DPSS) laser. Each of the laser pulses 800, 850 have different patterns by which the energy is emitted. The first pulse 800 is a shorter and sharper pulse of a set time and the second pulse 850 is a longer/wider pulse with a shallower rise and steeper fall. The characteristics of the transmitted laser pulses 800, 850 can be used to enhance detection of lower energy pulses, and can also reduce erroneous detection of pulses that do not conform to the pulse characteristics.

The first laser pulse 800 can be compared to a low trigger threshold 802 and a high trigger threshold 804 to time the duration of the pulse, e.g., the time to cross the thresholds 802, 804 going up (rise) to the time to cross going down (fall). Pulses that do not conform (within margins for distance and pulse reflectivity) and/or meet certain ratio characteristics between durations can be rejected. Relatively lower energy pulses can be detected. In embodiments, thresholds similar to the thresholds Vth1, Vth2 can be used for the High Trigger and Low Trigger illustrated in FIG. 8 and similar circuitry as that shown in FIG. 7A can be used to process received pulses.

As can be seen, the DPSS laser pulse 850 has a leaky period before the laser fires that can also be timed against the durations for the high and low trigger and compared to one another.

For example, if a detector expects to receive pulses of the first type 800 pulses of the second type 802 can be discriminated, e.g., rejected as noise. In embodiments, a detector can reject pulses that are not of the expected type. For example, in automotive applications there may be a number of devices transmitting pulse of various types. By discriminating pulses from other types of lasers by pulse shape, false detections can be reduced.

In embodiments, pulse characteristics can be evaluated, for example, by design, where through manufacturing properties are understood, or characterized per unit using an offline characterization, or by using a fiber delay loop or target at a known distance with known reflectivity.

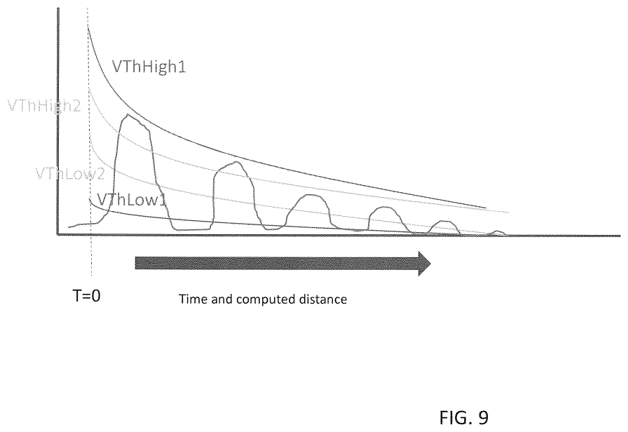

FIG. 9 shows an example signal return that can be processed in accordance with example embodiments of the disclosure. An initial set of time-dependent VThHigh1 and VThLow1 thresholds is established. After the first few returns come back, an actual decay rate can be determined as well as an understanding as to the reflectivity of objects in this environment. Based on the processing of the first few returns, thresholds can be reset to be VThHigh2 and VThLow2 and used either to determine admissibility of new returns to the memory, and/or prioritize the removal of past pulses based on the understood return characteristic of many pulses over time. In some embodiments, returns can simply be deleted or flagged as likely to be noise that do not fit the adjusted set of thresholds.

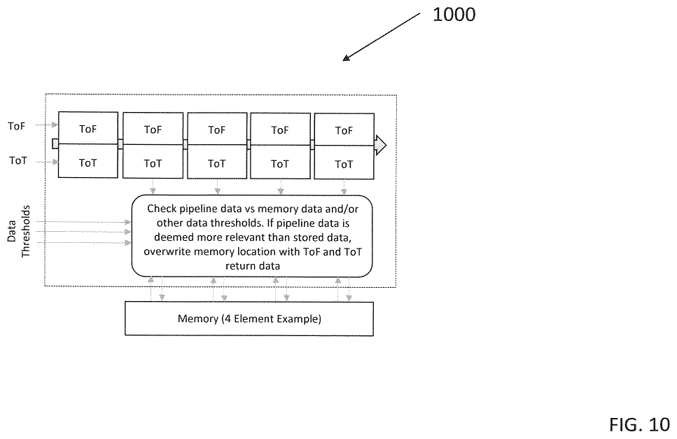

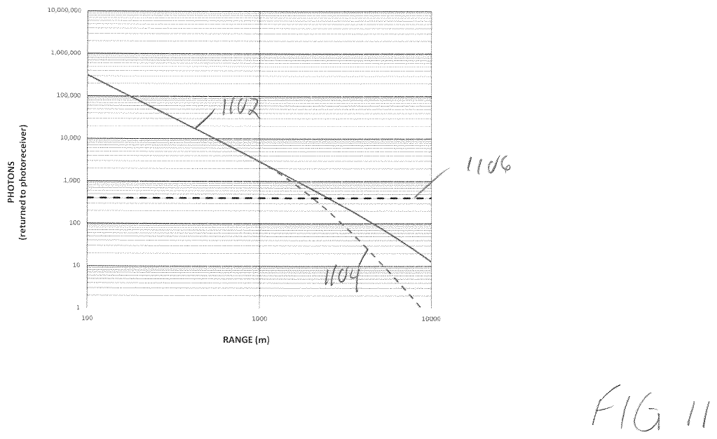

FIG. 10 shows an example pulse sorter embodiment 1000 for the system of FIG. 3. The pulse sorter module 1000 enables a receiver to logically evaluate the return data (e.g., ToF and ToT data) versus existing data in memory, as well as additional data thresholds, without compromising the pulse pair resolution of the receiver. In the example embodiment, pipeline system return data is shifted through pipeline registers at a receiver clock rate that has a period close to the pulse pair resolution of the receiver. Each element of the pipeline is evaluated against stored data and data thresholds. If an element of pipeline data is deemed more relevant than existing memory data and passes data thresholds, memory data is overwritten by a pipeline element and the pipeline element data is reset.

It is understood that discriminator thresholds can be selected in a variety of ways. In some embodiments, threshold values are programmed to have time varying characteristics with respect to the time of the transmitted laser pulse. Voltage threshold levels may be held constant during the time of flight of the laser pulse and/or one or more of the thresholds may be decreased in value during the time of flight of the laser pulse to compensate for the reduction in the return pulse return values as a function of target range (R). Examples of range dependent thresholds include thresholds that are proportional to values for Lambertian targets larger than the laser beam diameter decay approximately as 1/R\hat{ }2, threshold values for wire or linear targets larger than the laser beam diameter decay approximately as 1/R\hat{ }3, and threshold values for Lambertian targets smaller than the laser beam diameter decay approximately as 1/R\hat{ }4, for example. In some embodiments, threshold levels can reduce in value only after a laser pulse is detected and/or may be reduced in value a time interval before or after a laser pulse is transmitted.

In another aspect, example embodiments of the disclosure provide methods and apparatus for a multiple threshold detector (MTD). The photons returned from a laser are a function of the laser pulse energy, the atmospheric attenuation and the target size, texture, and other reflective characteristics.

FIG. 11 shows return in logarithmic scale from a notional laser having divergence including returns 1102 from a target that is larger than the laser beam size (at range) and returns 1104 where the size of the laser beam becomes larger than the target. The underfilled targets generally follow a 1/R\hat{ }2 dependence and the resolved targets a 1/R\hat{ }4 dependence as a function of range, R. An example photon referred voltage threshold level 1106 is also shown.

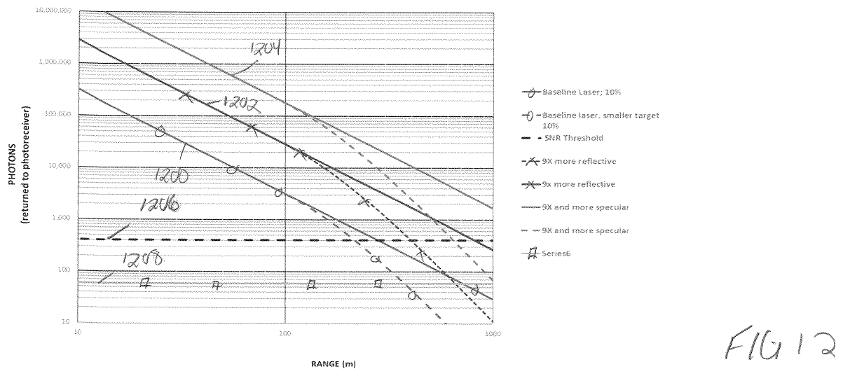

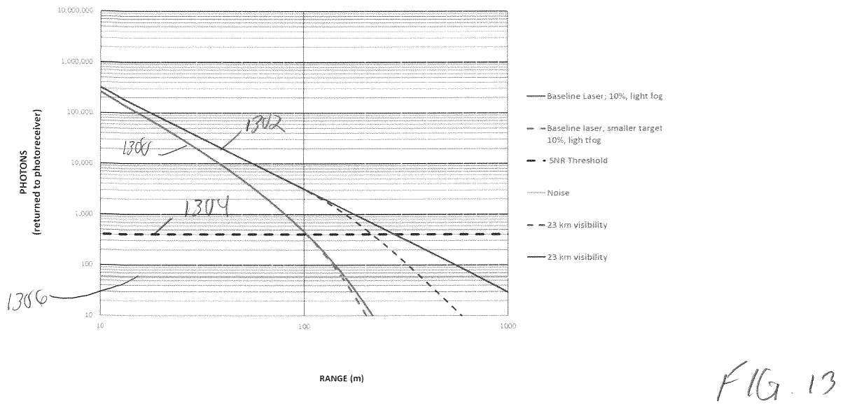

FIG. 12 shows example photon returns from three different targets on a logarithmic scale. A first 1200 target is a 10% reflective diffuse target (Lambertian) that is facetted (multiple facets with different orientation relative to the laser beam orientation). A second target 1202 is 90% reflective, showing 9X greater signal return. A third target 1204 is a 90% reflective target with more specular reflection, and which is planar. As can be seen, target returns, at any range, can vary in amplitude over 1000× based on the size, the reflectivity, and the surface characteristics.

A example photon referred, voltage threshold level 1206 is shown. A first line 1208 shows a photon referred, detector noise level (e.g., noise equivalent input). A threshold detector may be set at a multiple of the noise level to establish the signal to noise ratio (SNR) that optimizes the probability of detection for a given false alarm rate.

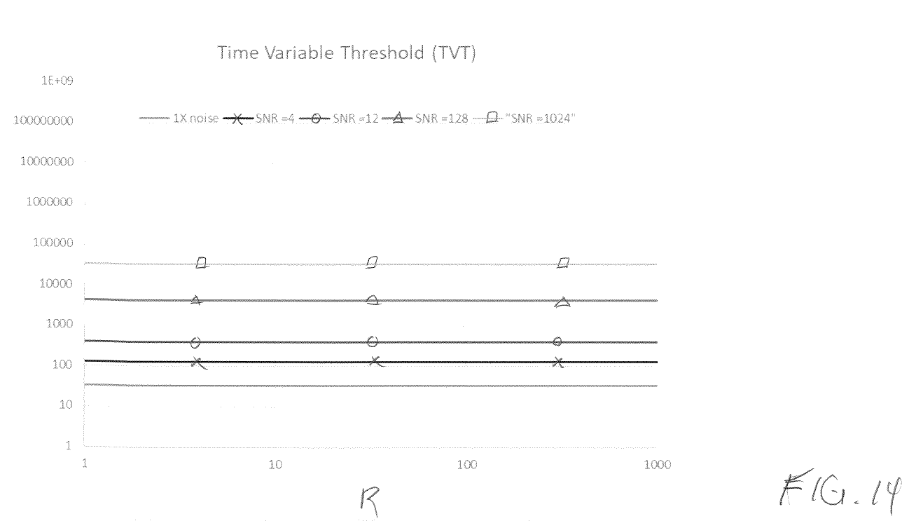

FIG. 13 shows the photons returned from a laser is a function of atmospheric attenuation. A first plot 1300 shows baseline laser return of 10% in light fog. A second plot 1302 shows a baseline laser return 10% for a smaller target. A third plot 1304 shows an example signal-to-noise (SNR) threshold. A fourth plot 1306 shows an example noise level. As can be seen, the smaller target return 1302 falls off for 23 km visibility after a given range.

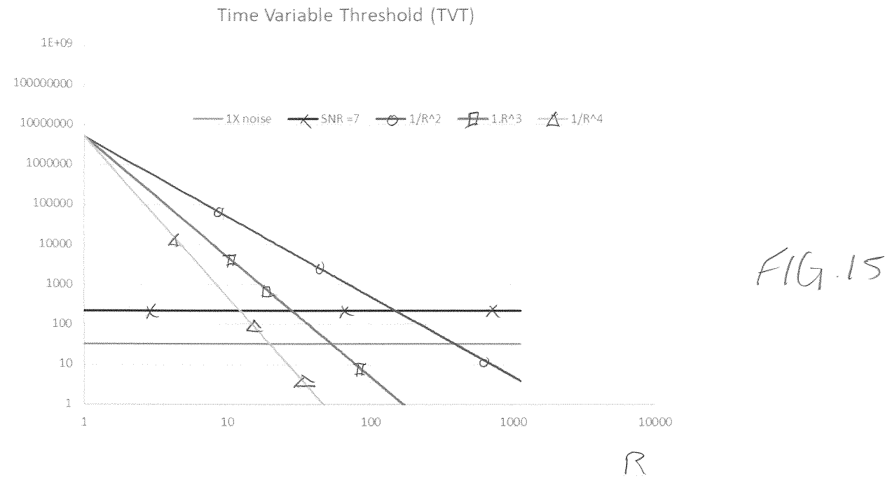

FIG. 14 shows a series of photon referred voltage levels from a multiple threshold (MT) detector. In example embodiments, threshold levels are set at multiples of a photon referred noise floor. In the illustrated embodiment, thresholds are set at 1X the noise floor, 4X the noise floor, 12X the noise floor, 128X the noise floor, and 1024X the noise floor.

It is understood that any practical number of thresholds using any suitable scheme to set thresholds can be used the needs of a particular application.

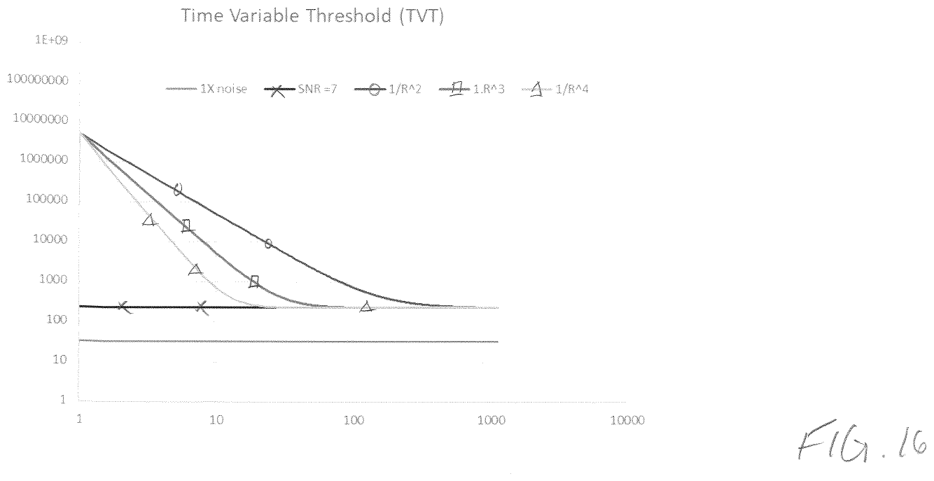

FIG. 15 shows a series of photon referred voltage levels from a multiple threshold (MT) detector (target returns not shown). In the illustrated embodiment, first and second thresholds are referenced to the noise floor as SNR=1 and SNR=7. Third (1/R²), fourth (1/R³), and fifth (1/R⁴) threshold levels decay with time, starting at range R=1 (approximately the time of the laser transmittal).

The decaying threshold levels (1/R², 1/R³, 1/R⁴) approximate the returns from different sized targets. It is understood that the decaying thresholds are time-dependent. The fifth threshold corresponds to 1/R⁴ for a target that is smaller than the laser beam (fully resolved by the laser beam). The fourth threshold corresponds to 1/R³ to represent a wire, for example. The third threshold corresponds to 1/R² to represent a large target.

The threshold levels are detector referred and set for an anticipated photon return any sized and shaped target for which the reflectivity can vary. It is understood that each threshold level can be adjusted based on these properties to meet the needs of a particular application. In the illustrated embodiment, the decaying thresholds fall to SNR=1.

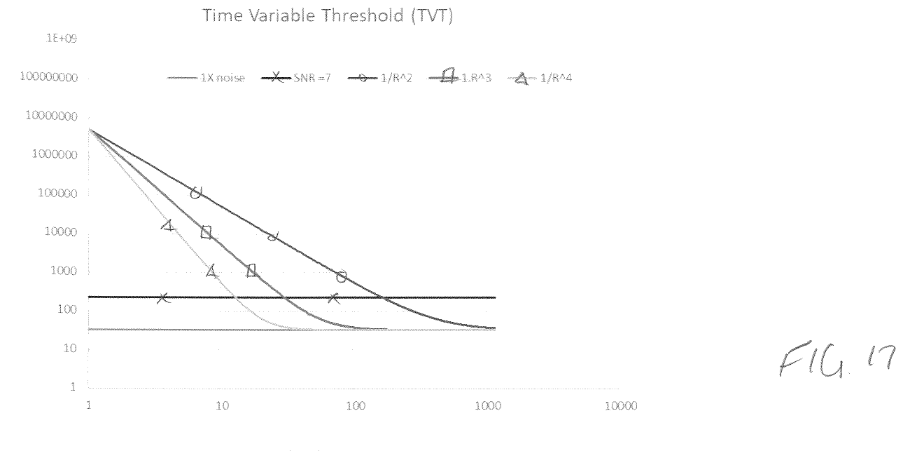

FIG. 16 shows decaying thresholds falling from a high photon equivalent voltage level to a threshold level related to the SNR, shown as SNR=7. At this level, false alarms from noise can be reduced. Logic can process data from the detectors to determine target, noise, etc., information.

For example, at close ranges, if the lower two thresholds (1X noise and 7X noise) are exceeded, but none of the three higher threshold levels (1/R², 1/R³, 1/R⁴), the return can be estimated to be noise. Similarly, if any of the higher levels (1/R², 1/R³, 1/R⁴) are exceeded, at any time, or range of times, but not all of the lower thresholds (1X noise and 7X noise), it can be estimated to be noise.

Return levels in which one or more lower threshold levels (1X noise and 7X noise) are exceeded, referenced to a given range, as well as one or more of the time decaying thresholds (1/R², 1/R³, 1/R⁴), can be used to infer characteristics of the target.

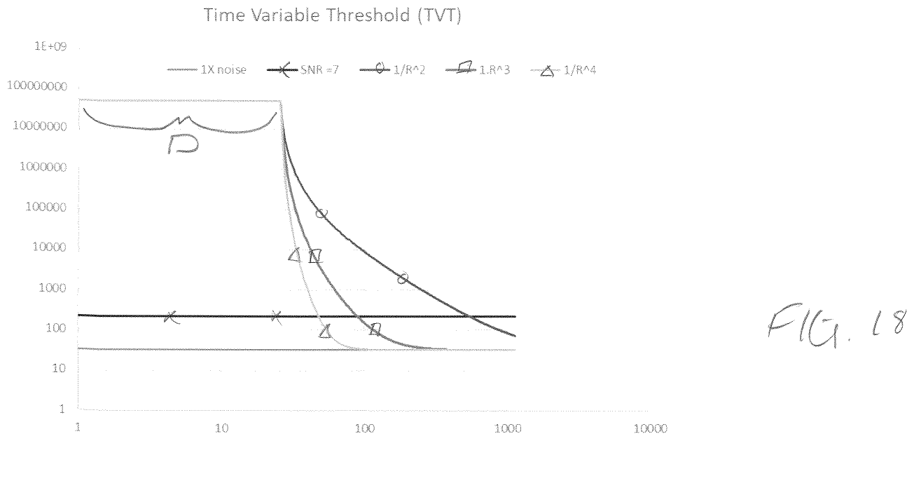

FIG. 17 is similar to FIG. 16 but with the decaying thresholds (1/R², 1/R³, 1/R⁴) decaying, but not falling below the SNR=1 set threshold so that similar target estimations can be made. By decaying below the SNR-(for example)=7 level, this provides a better discrimination between noise and signal below that SNR=7 detection level (sensitivity level).

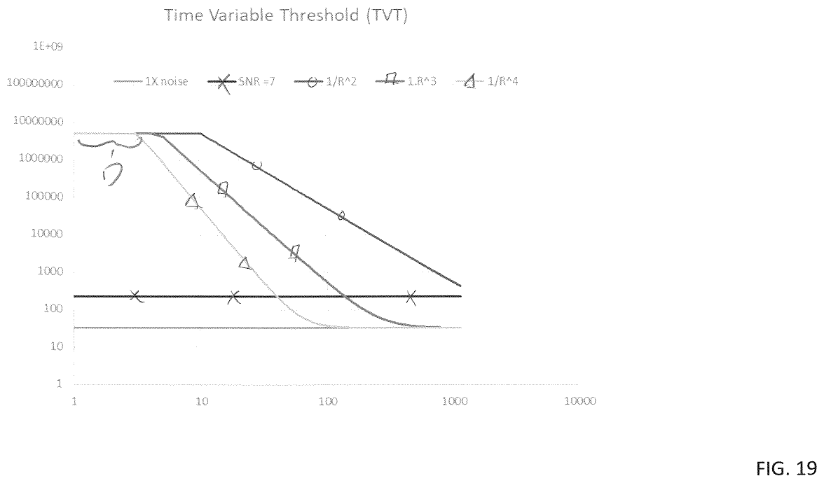

FIG. 18 shows threshold decay initiated after a time delay D. A delay may be helpful since some circuits may have a limited dynamic range (e.g., 20 dB), where the target signals may have 60 dB or more of dynamic range depending on the laser and the target range. These signal levels may saturate the circuit. The time delay D to initiate decay may be based on the estimate, e.g., range based, of when the return signals are within the photoreceivers dynamic range.

FIG. 19 shows threshold levels are initiated, after a delay D, based on the estimated returns from different sized and shaped targets, as a function of range (time).

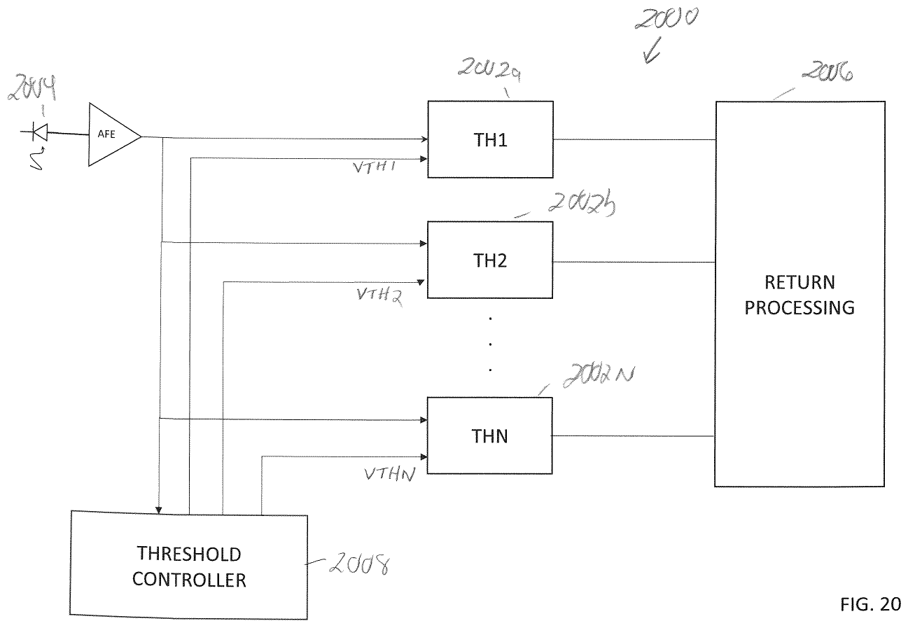

FIG. 20 shows an example system 2000 having multiple threshold detectors 2002a-N configured to receive signal return from a photodetector 2004. A return processing module 2006 can process the information from the threshold detectors 2002 to determine range, amplitude, etc., of the signal return. In the illustrated embodiment, each of the threshold detectors 2002a-N has a unique voltage threshold level VTH1, TH2, VTHN to meet the needs of a particular application. In embodiments, thresholds can be provided to the detectors 2002 by a threshold controller 2008.

As described above, the threshold detectors 2002 can have different threshold voltages VTH1, TH2, VTHN for at least part of the duration of the time of flight. In some embodiments, the threshold voltages VTH1, TH2, VTHN may be referenced to the noise level of the detector. In some embodiments, at least one of the reference levels of the threshold detectors 2002 decays in its value as a function of the time that the light reflecting from the target travels, as a function of the target range (R), such as a decay time between 1/R\hat{ }2 and 1/R\hat{ }4, a decay time of 1/R^{x}, where x is between, for example, 1 and 10, a decay time of 1/RC, where R is a resistor value and C is a capacitor. In other embodiments, decay time is calculated based on the estimated optical returns based on target size, orientation, reflectivity, or other physical characteristic. In some embodiments, at least one of the threshold voltages VTH1, TH2, VTHN decays as a function of the measured or estimated atmospheric attenuation coefficients A, for example a decay proportional to EXP(−A*R*2), where A, expressed in 1/m, for example, can be between values 1E-2 (1/m) and 1E-5 (1/m) for 1550 nm light representing dense fog and clear visibility respectively. Decay time may be calculated to be a function of both the physical target characteristics, including size, orientation, and reflectivity, as well as the estimated or measured atmospheric conditions, such as when the decay is proportional to EXP(−A*R*2)/1/R^{x}, and/or the decay is proportional to EXP(−A*R*2)/1/RC.

In some embodiments, to accommodate the limited dynamic range of circuit components, the decay time is delayed for a period of time D corresponding to a range R, (D=2R/c, where c is the speed of light in the medium) where the expected signal is calculated to be a function of both the physical target characteristics, including size, orientation, and reflectivity, as well as the estimated or measured atmospheric conditions.

In some embodiments, the return processing module 2006 can detect a target of a certain size or orientation at a certain range and may discriminate the target from noise, such as electrical and/or optical noise. As described above, the multiple threshold voltages VTH1, TH2, VTHN can be used to record the rising and falling edges of signal return and use the differences in the time of the rising and falling signal edges to infer pulse amplitude using time over threshold (TOT) amplitude inference. In some embodiments, pulse amplitude information is normalized based on the calculated target range using values of more than one threshold level.

In some embodiments, threshold voltages VTH1, TH2, VTHN are dynamically adjusted as a function of the scan angle, output pulse energy, output pulse beam divergence or beam shape, and/or output pulse beam temporal shape.

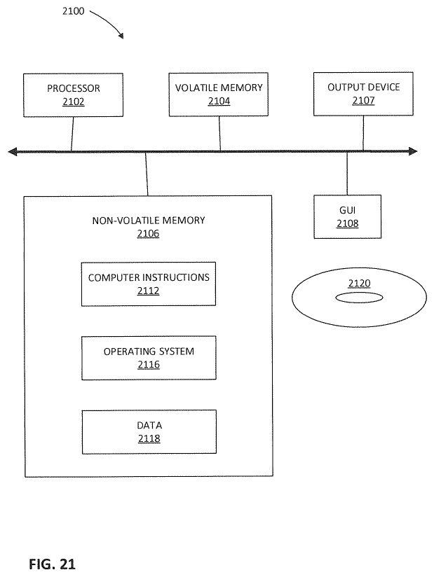

FIG. 21 shows an exemplary computer 2100 that can perform at least part of the processing described herein. For example, the computer 2100 can perform processing to provide and/or adjust thresholds, control memory storage, and process signal return, as described above. The computer 2100 includes a processor 2102, a volatile memory 2104, a non-volatile memory 2106 (e.g., hard disk), an output device 2107 and a graphical user interface (GUI) 2108 (e.g., a mouse, a keyboard, a display, for example). The non-volatile memory 2106 stores computer instructions 2112, an operating system 2116 and data 2118. In one example, the computer instructions 2112 are executed by the processor 2102 out of volatile memory 2104. In one embodiment, an article 2120 comprises non-transitory computer-readable instructions.

Processing may be implemented in hardware, software, or a combination of the two. Processing may be implemented in computer programs executed on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform processing and to generate output information.

The system can perform processing, at least in part, via a computer program product, (e.g., in a machine-readable storage device), for execution by, or to control the operation of, data processing apparatus (e.g., a programmable processor, a computer, or multiple computers). Each such program may be implemented in a high-level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer.

Processing may also be implemented as a machine-readable storage medium, configured with a computer program, where upon execution, instructions in the computer program cause the computer to operate.

Processing may be performed by one or more programmable embedded processors executing one or more computer programs to perform the functions of the system. All or part of the system may be implemented as, special purpose logic circuitry (e.g., an FPGA (field programmable gate array) and/or an ASIC (application-specific integrated circuit)).

Having described exemplary embodiments of the disclosure, it will now become apparent to one of ordinary skill in the art that other embodiments incorporating their concepts may also be used. The embodiments contained herein should not be limited to disclosed embodiments but rather should be limited only by the spirit and scope of the appended claims. All publications and references cited herein are expressly incorporated herein by reference in their entirety.

Elements of different embodiments described herein may be combined to form other embodiments not specifically set forth above. Various elements, which are described in the context of a single embodiment, may also be provided separately or in any suitable subcombination. Other embodiments not specifically described herein are also within the scope of the following claims.

What is claimed is:

1. A method, comprising:
receiving, at a photodetector of a detector system, signal return photons reflected by a target illuminated by laser energy;
comparing the signal return to at least one threshold to determine at least one amplitude and/or Time of Flight (ToF) parameter of the signal return to sort the signal return; and
storing, in a memory, at least one parameter of pulses in the signal return that exceeds the at least one threshold, wherein the at least one parameter includes the time of flight (ToF) and/or the time over threshold (ToT).

2. The method according to claim 1, further including overwriting a stored value for the at least one parameter having a value less than a parameter of a new pulse.

3. The method according to claim 1, wherein the at least one threshold includes at least three voltage thresholds.

4. The method according to claim 1, wherein the at least threshold comprises first and second thresholds that decay over range, and further including identifying as noise signal return that is above the first threshold or below the second threshold.

5. The method according to claim 4, wherein the first and second thresholds are programmed to decay proportional to a range of calculated target reflectivities at various ranges.

6. The method according to claim 1, wherein the at least one threshold comprises a threshold that decays.

7. The method according to claim 6, wherein the at least threshold comprises first and second thresholds that decay over range 1/R^{x}, where x is an number between 1 and 10.

8. The method according to claim 6, wherein the decay is between 1/R\hat{ }2 and 1/R\hat{ }4, where R is range.

9. The method according to claim 6, wherein the decay is based on estimated optical returns corresponding to target size, orientation, and/or reflectivity.

10. The method according to claim 6, wherein the decay is a function of atmospheric attenuation coefficients A.

11. The method according to claim 10, wherein the decay is proportional to EXP(−A*R*2), where A, expressed in 1/m, is between values 1E-2 (1/m) and 1E-5 (1/m) for 1550 nm light representing dense fog and clear visibility respectively.

12. The method according to claim 6, wherein the decay is a function of physical target characteristics including size, orientation, and reflectivity, and atmospheric conditions.

13. The method according to claim 6, wherein the decay is proportional to EXP(−A*R*2)*1/R^{x}.

14. The method according to claim 6, wherein the decay is proportional to EXP(−A*R*2)*1/R^{s}C.

15. The method according to claim 6, further including delaying the decay for a period of time D to accommodate a limited dynamic range of circuitry.

16. The method according to claim 1, wherein the at least one threshold is referenced to a noise level of the detector system.

17. The method according to claim 1, wherein the first threshold corresponds to a high trigger and the second threshold corresponds to a low trigger, wherein the high and low triggers are selected based on characteristics of the laser beam that illuminated the target.

18. The method according to claim 17, wherein the high and low triggers are selected based on a width of pulses generated by the laser.

19. The method according to claim 17, wherein the high and low triggers are selected based on a leakage characteristic of the laser.

20. The method according to claim 17, further including using the high and low triggers to record rising and falling edges of a pulse and using differences in the time of the rising and falling signal edges to determine pulse amplitude using time over threshold (TOT).

21. The method according to claim 1, wherein the at least one threshold comprises first and second thresholds that decay over range, and further including:
identifying as noise the signal return that is above the first threshold or below the second threshold; and
adjusting the first and second thresholds based upon updated target reflectivity.

22. The method according to claim 1, wherein the at least one threshold comprises first and second thresholds that decay over range, and further including:
identifying as noise signal return that is above the first threshold or below the second threshold; and
adjusting the first and second thresholds based upon updated decay information of the signal return.

23. The method according to claim 22, further including removing information stored in the memory based on the updated decay information.

24. The method according to claim 1, further including employing a pipeline pulse sorter to compare new pulse parameter data with the stored pulse parameter data to selectively overwrite the stored pulse parameter data.

25. The method according to claim 24, further including overwriting the stored pulse parameter data with more relevant new pulse parameter data based on the comparisons in the pipeline pulse sorter.

26. The method according to claim 1, wherein one or more of the threshold levels are dynamically adjustable as a function of scan angle.

27. The method according to claim 1, wherein the at least one threshold is adjustable as a function of an output pulse energy of the laser beam.

28. The method according to claim 1, wherein the least one threshold is adjustable as a function of an output pulse beam divergence and/or beam shape of the laser beam.

29. The method according to claim 1, wherein the at least one threshold is adjustable as a function of an output pulse beam temporal shape of the laser beam.

30. The method according to claim 1, wherein the at least one threshold comprises a multiple of a detector noise level.

31. A system, comprising:
a photodetector of a detector system to receive signal return photons reflected by a target illuminated by laser energy;
a discriminator to compare the signal return to at least one threshold to determine at least one amplitude and/or Time of Flight (ToF) parameter of the signal return to sort the signal return; and
a memory to store at least one parameter of pulses in the signal return that exceeds the at least one threshold, wherein the at least one parameter includes the time of flight (ToF) and/or the time over threshold (ToT).

32. The system according to claim 31, further including overwriting a stored value for the at least one parameter having a value less than a parameter of a new pulse.

33. The system according to claim 31, wherein the at least one threshold includes at least three voltage thresholds.

34. The system according to claim 31, wherein the at least threshold comprises first and second thresholds that decay over range, and further including identifying as noise signal return that is above the first threshold or below the second threshold.

35. The system according to claim 34, wherein the first and second thresholds are programmed to decay proportional to a range of calculated target reflectivities at various ranges.

36. The system according to claim 31, wherein the at least one threshold comprises a threshold that decays.

37. The system according to claim 36, wherein the at least threshold comprises first and second thresholds that decay over range 1/R^{x}, where x is an number between 1 and 10.

38. The system according to claim 36, wherein the decay is between 1/R\hat{ }2 and 1/R\hat{ }4, where R is range.

39. The system according to claim 36, wherein the decay is based on estimated optical returns corresponding to target size, orientation, and/or reflectivity.

40. The system according to claim 36, wherein the decay is a function of atmospheric attenuation coefficients A.

41. The system according to claim 40, wherein the decay is proportional to EXP(−A*R*2), where A, expressed in 1/m, is between values 1E-2 (1/m) and 1E-5 (1/m) for 1550 nm light representing dense fog and clear visibility respectively.

42. The system according to claim 36, wherein the decay is a function of physical target characteristics including size, orientation, and reflectivity, and atmospheric conditions.

43. The system according to claim 36, wherein the decay is proportional to EXP(−A*R*2)*1/R^{x}.

44. The system according to claim 36, wherein the decay is proportional to EXP(−A*R*2)*1/R^{s}C.

45. The system according to claim 36, further including delaying the decay for a period of time D to accommodate a limited dynamic range of circuitry.

46. The system according to claim 31, wherein the at least one threshold is referenced to a noise level of the detector system.

47. The system according to claim 31, wherein the first threshold corresponds to a high trigger and the second threshold corresponds to a low trigger, wherein the high and low triggers are selected based on characteristics of the laser beam that illuminated the target.

48. The system according to claim 47, wherein the high and low triggers are selected based on a width of pulses generated by the laser.

49. The system according to claim 47, wherein the high and low triggers are selected based on a leakage characteristic of the laser.

50. The system according to claim 49, further including using the high and low triggers to record rising and falling edges of a pulse and using differences in the time of the rising and falling signal edges to determine pulse amplitude using time over threshold (TOT).

51. The system according to claim 31, wherein the at least one threshold comprises first and second thresholds that decay over range, and wherein the system is configured to:
identify as noise the signal return that is above the first threshold or below the second threshold; and
adjust the first and second thresholds based upon updated target reflectivity.

52. The system according to claim 31, wherein the at least one threshold comprises first and second thresholds that decay over range, and wherein the system is configured to:
identify as noise signal return that is above the first threshold or below the second threshold; and
adjust the first and second thresholds based upon updated decay information of the signal return.

53. The system according to claim 52, further including removing information stored in the memory based on the updated decay information.

54. The system according to claim 31, further including employing a pipeline pulse sorter to compare new pulse parameter data with the stored pulse parameter data to selectively overwrite the stored pulse parameter data.

55. The system according to claim 54, further including overwriting the stored pulse parameter data with more relevant new pulse parameter data based on the comparisons in the pipeline pulse sorter.

56. The system according to claim 31, wherein one or more of the threshold levels are dynamically adjustable as a function of scan angle.

57. The system according to claim 31, wherein the at least one threshold is adjustable as a function of an output pulse energy of the laser beam.

58. The system according to claim 31, wherein the least one threshold is adjustable as a function of an output pulse beam divergence and/or beam shape of the laser beam.

59. The system according to claim 31, wherein the at least one threshold is adjustable as a function of an output pulse beam temporal shape of the laser beam.

60. The method according to claim 31, wherein the at least one threshold comprises a multiple of a detector noise level.
